(19) United States
(12) Patent Application Publication
(10) Pub. No.: US 2026/0106740 A1
(43) Pub. Date: Apr. 16, 2026

(54) COMMUNICATION DEVICE, COMMUNICATION METHOD, AND NON-TRANSITORY COMPUTER-READABLE STORAGE MEDIUM

(71) Applicant: NEC Corporation, Tokyo (JP)

(72) Inventor: Ken-ichiro YOSHINO, Tokyo (JP)

(73) Assignee: NEC Corporation, Tokyo (JP)

(21) Appl. No.: 19/346,906

(22) Filed: Oct. 1, 2025

(30) Foreign Application Priority Data
Oct. 11, 2024 (JP) 2024-179342

(51) Int. Cl. H04L 9/08

(52) U.S. Cl. CPC H04L 9/0861

(57) ABSTRACT

A communication device includes generation means for generating an encryption key consumed in encryption communication, determination means for determining whether the generation of the encryption key by the generation means is normally performed, and selection means for selecting, according to a determination result by the determination means, any one of first communication processing using a first authentication key that is an authentication key generated from the encryption key and second communication processing that does not consume the encryption key.

This application is based upon and claims the benefit of priority from Japanese Patent Application No. 2024-179342, filed on Oct. 11, 2024, the disclosure of which is incorporated herein in its entirety by reference.

### TECHNICAL FIELD

The present disclosure relates to a communication device, a communication system, a communication method, and a program.

### BACKGROUND ART

As a technology for ensuring high confidentiality in communication, a technology referred to as quantum key distribution (QKD) is known. In a quantum key distribution system (also referred to as a QKD system) that executes the quantum key distribution, by transmitting and receiving a quantum state between communication devices via a communication path (also referred to as a quantum communication path) capable of transmitting the quantum state, an encryption key having high confidentiality can be shared between the communication devices. Various technologies have been proposed in relation to the quantum key distribution, and for example, JP 2016-181814 A discloses a technology that aims to perform encryption data communication according to a one-time pad method by using a shared application key and reduce a processing delay in an operation of sharing encryption keys.

### SUMMARY

A communication device according to an exemplary aspect of the present disclosure includes generation means for generating an encryption key consumed in encryption communication, determination means for determining whether the generation of the encryption key by the generation means is normally performed, and selection means for selecting, according to a determination result by the determination means, any one of first communication processing using a first authentication key that is an authentication key generated from the encryption key and second communication processing that does not consume the encryption key.

A communication system according to an exemplary aspect of the present disclosure is a communication system including a first communication device and a second communication device, and

the first communication device includes first generation means for generating an encryption key consumed in encryption communication, first determination means for determining whether the generation of the encryption key by the first generation means is normally performed, and first selection means for selecting, according to a determination result by the first determination means, any one of first communication processing using a first authentication key that is an authentication key generated from the encryption key and second communication processing that does not consume the encryption key, and

the second communication device includes second generation means for generating an encryption key consumed in encryption communication, second determination means for determining whether the generation of the encryption key by the second generation means is normally performed, and second selection means for selecting, according to a determination result by the second determination means, any one of first communication processing using a first authentication key that is an authentication key generated from the encryption key and second communication processing that does not consume the encryption key.

A communication method according to an exemplary aspect of the present disclosure includes determining whether generation of an encryption key consumed in encryption communication by generation means for generating the encryption key is normally performed, and selecting, according to a determination result by the determining, any one of first communication processing using a first authentication key that is an authentication key generated from the encryption key and second communication processing that does not consume the encryption key.

A program according to an exemplary aspect of the present disclosure is a program for causing a computer to function as a communication control device, and the computer is caused to execute determination processing of determining whether generation of an encryption key consumed in encryption communication by generation means for generating the encryption key is normally performed, and selection processing of selecting, according to a determination result by the determination processing, any one of first communication processing using a first authentication key that is an authentication key generated from the encryption key and second communication processing that does not consume the encryption key.

### BRIEF DESCRIPTION OF THE DRAWINGS

FIG. 1 is a block diagram illustrating a configuration of a communication device according to the present disclosure;

FIG. 2 is a flowchart illustrating a flow of a communication method according to the present disclosure;

FIG. 3 is a block diagram illustrating a configuration of a communication system according to the present disclosure;

FIG. 4 is a block diagram illustrating a configuration of a communication system according to the present disclosure;

FIG. 5 is a flowchart illustrating a flow of a communication method according to the present disclosure;

FIG. 6A is first in a diagram for describing an example of a key generation protocol according to the present disclosure,

FIG. 6B is second in a diagram for describing an example of a key generation protocol according to the present disclosure; and

FIG. 7 is a block diagram illustrating a hardware configuration of a communication device according to the present disclosure.

### EXAMPLE EMBODIMENT

Hereinafter, example embodiments of the present disclosure will be described. However, the present disclosure is not limited to the exemplary example embodiments to be described below, and various modifications can be made within the scope described in the claims. For example, example embodiments obtained by appropriately combining technologies (some or all of things or methods) adopted in the exemplary example embodiments to be described below can also be included in the scope of the present disclosure. Example embodiments obtained by appropriately omitting some of the technologies adopted in the exemplary example embodiments to be described below can also be included in the scope of the present disclosure. Effects mentioned in the exemplary example embodiments to be described below are examples of effects expected in the exemplary example embodiments, and do not define extension of the present disclosure. That is, example embodiments that do not achieve the effects mentioned in the exemplary example embodiments to be described below can also be included in the scope of the present disclosure.

### First Exemplary Example Embodiment

A first exemplary example embodiment as an example of the example embodiments of the present disclosure will be described in detail with reference to the drawings. The present exemplary example embodiment is a basic form of each exemplary example embodiment to be described below. An application range of each technology adopted in the present exemplary example embodiment is not limited to the present exemplary example embodiment. That is, each technology adopted in the present exemplary example embodiment can also be adopted in another exemplary example embodiment included in the present disclosure within a range in which no particular technical problem occurs. Each technology illustrated in the drawings referred to for describing the present exemplary example embodiment can also be adopted in another exemplary example embodiment included in the present disclosure within a range in which no particular technical problem occurs.

### Configuration of Communication Device

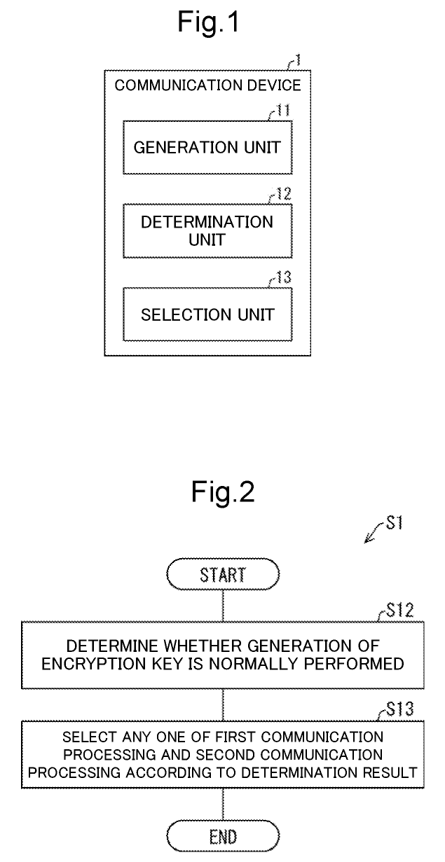

A configuration of a communication device 1 according to the present exemplary example embodiment will be described with reference to FIG. 1. As an example, the communication device 1 is a communication device constituting a quantum key distribution system (also referred to as a QKD system) that executes quantum key distribution (QKD), and includes a generation unit 11, a determination unit 12, and a selection unit 13, as illustrated in FIG. 1. The communication device 1 may be referred to as a quantum key distribution device or a QKD device.

### Generation Unit 11

The generation unit 11 generates an encryption key consumed in encryption communication. As an example, the generation unit 11 is connected to a key generation unit of a communication device on a partner side via a communication path (also referred to as a quantum communication path) capable of transmitting a quantum state, and generates an encryption key shared with the key generation unit on the partner side according to a predetermined key generation protocol. The generation unit 11 accumulates the generated encryption keys. The encryption communication that consumes the generated encryption key may include, as an example, an authentication process included in the predetermined key generation protocol by the generation unit 11 or an authentication process separately executed outside the key generation protocol, but this does not limit the present exemplary example embodiment.

### Determination Unit 12

The determination unit 12 determines whether the generation of the encryption key by the generation unit 11 is normally performed. As an example, the determination unit 12 may determine whether the generation of the encryption key by the generation unit 11 is normally performed with reference to a remaining amount of the generated encryption keys accumulated in the generation unit 11. As an example, the determination unit 12 may • determine that the generation of the encryption key by the generation unit 11 is normally performed in a case where a manner of reduction of the remaining amount of the generated encryption keys satisfies a predetermined condition, and • determine that the generation of the encryption key by the generation unit 11 is not normally performed in a case where the manner of reduction of the remaining amount of the generated encryption keys does not satisfy the predetermined condition.

The determination unit 12 may acquire, from a control unit included in the communication device or the outside of the communication device, information related to • whether calibration is being performed, • whether recovery work from failure is being performed, or • presence or absence of occurrence of a fault, noise, or the like in the communication path, and determine whether the generation of the encryption key by the generation unit 11 is normally performed with reference to the acquired information. As an example, the determination unit 12 may determine that the generation of the encryption key by the generation unit 11 is not normally performed in a case where the acquired information indicates that • the calibration is being performed, • the recovery work from the failure is being performed, or • the fault or the noise has occurred in the communication path. However, these examples do not limit the present exemplary example embodiment.

### Selection Unit 13

The selection unit 13 selects, according to a determination result by the determination unit 12, any one of first communication processing using a first authentication key that is an authentication key generated from the encryption key and second communication processing that does not consume the encryption key. As an example, the selection unit 13 performs processing of • selecting the first communication processing in a case where the determination unit 12 determines that the generation of the encryption key is normally performed, and • selecting the second communication processing in a case where the determination unit 12 determines that the generation of the encryption key is not normally performed. Here, the first communication processing is an example of the above-described encryption communication.

The second communication processing may also be regarded as an example of the above-described encryption communication. However, in the second communication processing, the encryption key generated by the generation unit 11 is not consumed.

The second communication processing may be communication processing using a second authentication key that is an authentication key generated without using the encryption key. Here, the second authentication key is also referred to as a dummy key, and is, as an example, an authentication key generated independently of the encryption key. As an example, the dummy key may be a fixed key such as a key including all zeros, or may be a key that is randomly generated.

As an example, the communication processing selected by the selection unit 13 is executed in the above-described authentication process included in the key generation protocol executed by the generation unit 11 or an authentication process associated with the key generation protocol. The authentication process includes message authentication as an example. More specifically, the authentication process includes transmission and reception of a message authentication code (MAC). However, these examples do not limit the present exemplary example embodiment.

### Effect of Communication Device

As described above, the communication device 1 adopts the configuration including the generation unit 11 that generates an encryption key consumed in encryption communication, the determination unit 12 that determines whether the generation of the encryption key by the generation unit 11 is normally performed, and the selection unit 13 that selects, according to a determination result by the determination unit 12, any one of first communication processing using a first authentication key that is an authentication key generated from the encryption key and second communication processing that does not consume the encryption key.

With the above configuration, since any one of the first communication processing using the first authentication key that is the authentication key generated from the encryption key and the second communication processing that does not consume the encryption key is selected according to the determination result by the determination unit 12, it is possible to suppress reduction in a remaining amount of the encryption keys even in a case where the generation of the encryption keys by the generation unit 11 is not normally performed.

### Flow of Communication Method

A flow of a communication method S1 according to the present exemplary example embodiment will be described with reference to FIG. 2. FIG. 2 is a flowchart illustrating the flow of the communication method S1. The communication method S1 is executed by the above-described communication device 1, as an example. As illustrated in FIG. 2, the communication method S1 includes determination processing (process, step) S12 and selection processing (process, step) S13.

### Step S12

In step S12, the determination unit 12 of the communication device 1 determines whether generation of an encryption key by the generation unit 11 that generates the encryption key consumed in encryption communication is normally performed. Since the generation processing of the encryption key by the generation unit 11 and the determination processing by the determination unit 12 have been described above, description thereof will be omitted here.

### Step S13

Subsequently, in step S13, the selection unit 13 of the communication device 1 selects, according to a determination result in step S12, any one of first communication processing using a first authentication key that is an authentication key generated from the encryption key and second communication processing that does not consume the encryption key. Since the specific processing by the selection unit 13 has been described above, description thereof will be omitted here.

### Effect of Communication Method

As described above, the communication method S1 includes determining whether generation of an encryption key consumed in encryption communication by generation means for generating the encryption key is normally performed, and selecting, according to a determination result by the determining, any one of first communication processing using a first authentication key that is an authentication key generated from the encryption key and second communication processing that does not consume the encryption key. With the above configuration, an effect similar to that of the communication device 1 is achieved.

### Configuration of Communication System

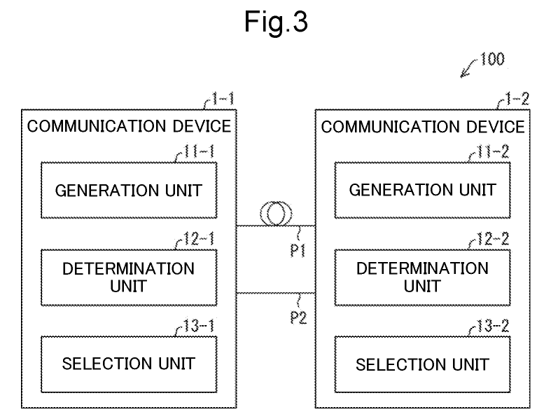

Subsequently, a configuration of a communication system 100 according to the present exemplary example embodiment will be described with reference to FIG. 3. As illustrated in FIG. 3, the communication system 100 includes a first communication device 1-1 and a second communication device 1-2. As illustrated in FIG. 3, the first communication device 1-1 and the second communication device 1-2 are connected to each other via a communication path P1 and a communication path P2.

Here, the communication path P1 is a communication path (quantum communication path) capable of transmitting a quantum state. On the other hand, the communication path P2 is a communication path prepared separately from the communication path P1, and does not need to be able to transmit the quantum state, and is also referred to as a classical communication path.

### First Communication Device

As illustrated in FIG. 3, the first communication device 1-1 includes a generation unit 11-1, a determination unit 12-1, and a selection unit 13-1. The generation unit 11-1, the determination unit 12-1, and the selection unit 13-1 may be referred to as the first generation unit 11-1, the first determination unit 12-1, and the first selection unit 13-1.

### Generation Unit 11-1

The generation unit 11-1 generates an encryption key consumed in encryption communication. The generation unit 11-1 is connected to a generation unit 11-2 included in the second communication device 1-2 via the above-described quantum communication path P1, and generates the encryption key shared with the generation unit 11-2 according to a predetermined key generation protocol. The generation unit 11-1 accumulates the generated encryption keys. The encryption communication that consumes the generated encryption key may include, as an example, an authentication process included in the predetermined key generation protocol by the generation unit 11-1 or an authentication process associated with the key generation protocol, but this does not limit the present exemplary example embodiment.

### Determination Unit 12-1

The determination unit 12-1 determines whether the generation of the encryption key by the generation unit 11-1 is normally performed. As an example, the determination unit 12-1 may determine whether the generation of the encryption key by the generation unit 11-1 is normally performed with reference to a remaining amount of the generated encryption keys accumulated in the generation unit 11-1. As an example, the determination unit 12-1 may • determine that the generation of the encryption key by the generation unit 11-1 is normally performed in a case where a manner of reduction of the remaining amount of the generated encryption keys satisfies a predetermined condition, and • determine that the generation of the encryption key by the generation unit 11-1 is not normally performed in a case where the manner of reduction of the remaining amount of the generated encryption keys does not satisfy the predetermined condition.

The determination unit 12-1 may acquire, from a control unit included in the communication device 1-1 or the outside of the communication device 1-1, information related to • whether calibration is being performed, • whether recovery work from failure is being performed, or • presence or absence of occurrence of a fault, noise, or the like in the communication path, and determine whether the generation of the encryption key by the generation unit 11-1 is normally performed with reference to the acquired information, similarly to the determination unit 12-included in the communication device 1 described with reference to FIG. 1.

### Selection Unit 13-1

The selection unit 13-1 selects, according to a determination result by the determination unit 12-1, any one of first communication processing using a first authentication key that is an authentication key generated from the encryption key and second communication processing that does not consume the encryption key. As an example, the selection unit 13-1 performs processing of • selecting the first communication processing in a case where the determination unit 12-1 determines that the generation of the encryption key is normally performed, and • selecting the second communication processing in a case where the determination unit 12-1 determines that the generation of the encryption key is not normally performed. Here, the first communication processing is an example of the above-described encryption communication.

The second communication processing may also be regarded as an example of the above-described encryption communication. However, in the second communication processing, the encryption key generated by the generation unit 11-1 is not consumed.

The second communication processing may be communication processing using a second authentication key that is an authentication key generated without using the encryption key. Here, the second authentication key is also referred to as a dummy key, and is, as an example, an authentication key randomly generated independently of the encryption key.

As an example, the communication processing selected by the selection unit 13-1 is executed in the above-described authentication process included in the key generation protocol executed by the generation unit 11-1 or an authentication process associated with the key generation protocol. The authentication process includes message authentication as an example. More specifically, the authentication process includes transmission and reception of a message authentication code (MAC). The communication processing selected by the selection unit 13-1 is executed via the classical communication path P2, as an example. However, these examples do not limit the present exemplary example embodiment.

### Second Communication Device

As illustrated in FIG. 3, the second communication device 1-2 includes the generation unit 11-2, a determination unit 12-2, and a selection unit 13-2. The generation unit 11-2, the determination unit 12-2, and the selection unit 13-2 may be referred to as the second generation unit 11-2, the second determination unit 12-2, and the second selection unit 13-2.

Generation Unit 11-2

The generation unit 11-2 generates an encryption key consumed in encryption communication. The generation unit 11-2 is connected to the generation unit 11-1 included in the first communication device 1-1 via the above-described quantum communication path P1, and generates the encryption key shared with the generation unit 11-1 according to a predetermined key generation protocol. The generation unit 11-2 accumulates the generated encryption keys. The encryption communication that consumes the generated encryption key may include, as an example, an authentication process included in the predetermined key generation protocol by the generation unit 11-2 or an authentication process associated with the key generation protocol, but this does not limit the present exemplary example embodiment.

### Determination Unit 12-2

The determination unit 12-2 determines whether the generation of the encryption key by the generation unit 11-2 is normally performed. As an example, the determination unit 12-2 may determine whether the generation of the encryption key by the generation unit 11-2 is normally performed with reference to a remaining amount of the generated encryption keys accumulated in the generation unit 11-2. Since the determination processing by the determination unit 12-2 is similar to the above-described determination processing by the determination unit 12-1, redundant description will be omitted. A determination logic in the determination unit 12-2 is preferably the same as a determination logic in the determination unit 12-1.

### Selection Unit 13-2

The selection unit 13-2 selects, according to a determination result by the determination unit 12-2, any one of first communication processing using a first authentication key that is an authentication key generated from the encryption key and second communication processing that does not consume the encryption key. As an example, the selection unit 13-2 performs processing of • selecting the first communication processing in a case where the determination unit 12-2 determines that the generation of the encryption key is normally performed, and • selecting the second communication processing in a case where the determination unit 12-2 determines that the generation of the encryption key is not normally performed. Since the selection processing by the selection unit 13-2 is similar to the above-described selection processing by the selection unit 13-1, redundant description will be omitted. A selection logic in the selection unit 13-2 is preferably the same as a selection logic in the selection unit 13-1.

### Effect of Communication System

As described above, the communication system 100 adopts the configuration including the first communication device 1-1 and the second communication device 1-2, and the first communication device 1-1 includes

the first generation unit 11-1 that generates an encryption key consumed in encryption communication,

the first determination unit 12-1 that determines whether the generation of the encryption key by the first generation unit 11-1 is normally performed, and

the first selection unit 13-1 that selects, according to a determination result by the first determination unit 12-1, any one of first communication processing using a first authentication key that is an authentication key generated from the encryption key and second communication processing that does not consume the encryption key, and the second communication device 1-2 includes

the second generation unit 11-2 that generates an encryption key consumed in encryption communication,

the second determination unit 12-2 that determines whether the generation of the encryption key by the second generation unit 11-2 is normally performed, and

the second selection unit 13-2 that selects, according to a determination result by the second determination unit 12-2, any one of first communication processing using a first authentication key that is an authentication key generated from the encryption key and second communication processing that does not consume the encryption key.

With the above configuration, the first selection unit 13-1 selects, according to the determination result by the first determination unit 12-1, any one of the first communication processing using the first authentication key that is the authentication key generated from the encryption key and the second communication processing that does not consume the encryption key. Similarly, the second selection unit 13-2 selects, according to the determination result by the second determination unit 12-2, any one of the first communication processing using the first authentication key that is the authentication key generated from the encryption key and the second communication processing that does not consume the encryption key. Therefore, with the above configuration, it is possible to suppress reduction in a remaining amount of the encryption keys even in a case where the generation of the encryption keys is not normally performed.

### Second Exemplary Example Embodiment

A second exemplary example embodiment as an example of the example embodiments of the present disclosure will be described in detail with reference to the drawings. Components having the same functions as the components described in the above-described exemplary example embodiment will be denoted by the same reference signs, and description thereof will be appropriately omitted. An application range of each technology adopted in the present exemplary example embodiment is not limited to the present exemplary example embodiment. That is, each technology adopted in the present exemplary example embodiment can also be adopted in another exemplary example embodiment included in the present disclosure within a range in which no particular technical problem occurs. Each technology illustrated in each of the drawings referred to for describing the present exemplary example embodiment can also be adopted in another exemplary example embodiment included in the present disclosure within a range in which no particular technical problem occurs.

### Configuration of Communication System

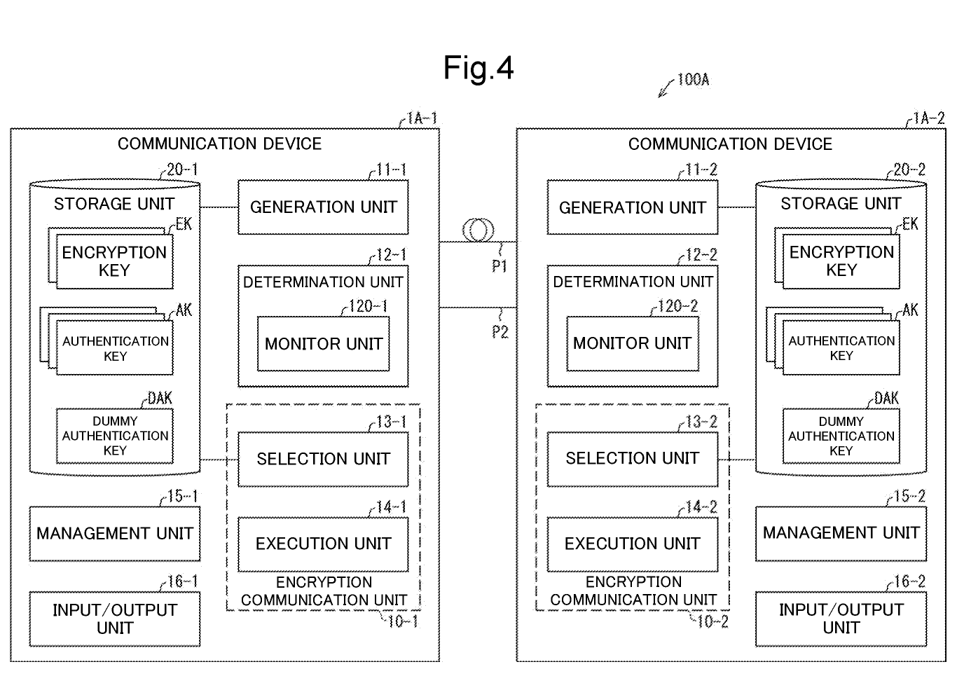

A configuration of a communication system 100A according to the present exemplary example embodiment will be described with reference to FIG. 4. FIG. 4 is a block diagram illustrating the configuration of the communication system 100A. As illustrated in FIG. 4, the communication system 100A includes a communication device 1A-1 and a communication device 1A-2. The communication device 1A-1 and the communication device 1A-2 may be referred to as the first communication device 1A-1 and the second communication device 1A-2.

As illustrated in FIG. 4, the communication device 1A-1 and the communication device 1A-2 are connected to each other via a communication path P1 and a communication path P2. The communication path P1 is a communication path (quantum communication path) capable of transmitting a quantum state. The communication path P1 can be achieved by, as an example, a dedicated optical fiber in order to transmit photons while maintaining the quantum state. However, this does not limit the present exemplary example embodiment. On the other hand, the communication path P2 is a communication path prepared separately from the communication path P1, and does not need to be able to transmit the quantum state, and is also referred to as a classical communication path. The communication path P2 can be achieved by, as an example, an optical fiber via an amplifier.

### Communication Device 1A-1 and Communication Device 1A-2

As illustrated in FIG. 4, the communication device 1A-1 includes, as an example, a generation unit 11-1, a determination unit 12-1, a selection unit 13-1, an execution unit 14-1, a management unit 15-1, an input/output unit 16-1, and a storage unit 20-1. Here, the selection unit 13-1 and the execution unit 14-1 constitute an encryption communication unit 10-1. Similarly, the communication device 1A-2 includes, as an example, a generation unit 11-2, a determination unit 12-2, a selection unit 13-2, an execution unit 14-2, a management unit 15-2, an input/output unit 16-2, and a storage unit 20-2. Here, the selection unit 13-2 and the execution unit 14-2 constitute an encryption communication unit 10-2.

In the following description, by using an index i or j (i = 1 or 2 and j = 1 or 2) indicating a branch number, reference such as the generation unit 11-i, the determination unit 12-i, the selection unit 13-i, the execution unit 14-i, the management unit 15-i, the input/output unit 16-i, and the storage unit 20-i will be made. As an example, the generation unit 11-i refers to the generation unit 11-1 or the generation unit 11-2. The same applies to other blocks.

### Generation Unit 11-i

The generation unit 11-i is connected to the generation unit 11-j (j ≠ i) included in the j-th communication device 1A-j via the above-described quantum communication path P1, and generates the encryption key EK shared with the generation unit 11-j according to a predetermined key generation protocol. The generation unit 11-i supplies the generated encryption key EK to the storage unit 20-i, and the encryption keys EK are accumulated in the storage unit 20-i.

The encryption communication that consumes the generated encryption key EK may include, as an example, an authentication process included in the predetermined key generation protocol by the generation unit 11-i or an authentication process associated with the key generation protocol, but this does not limit the present exemplary example embodiment. Note that, in the present exemplary example embodiment, the terms “communication processing” and “encryption communication” refer to those related to authentication of the classical communication path used for the generation of the key, and do not refer to “encryption communication (as an application) after the generation of the key”.

The generation unit 11-i also generates an authentication key AK from the generated encryption key EK, and stores the generated authentication key AK in the storage unit 20-i. Here, a specific example of generation processing of the authentication key AK by the generation unit 11-i does not limit the present exemplary example embodiment, but as an example, the generation unit 11-i may generate the authentication keys AK by cutting out a part of the generated encryption keys EK. A specific example of the key generation protocol executed between the generation unit 11-i and the generation unit 11-j (j ≠ i) will be described below with reference to another drawing.

### Determination Unit 12-i

The determination unit 12-i determines whether the generation of the encryption key EK by the generation unit 11-i is normally performed. As an example, the determination unit 12-i may determine whether the generation of the encryption key EK by the generation unit 11-i is normally performed with reference to a remaining amount of the generated encryption keys EK generated by the generation unit 11-i and accumulated in the storage unit 20-i. As an example, similarly to the first exemplary example embodiment, the determination unit 12-i may • determine that the generation of the encryption key EK by the generation unit 11-i is normally performed in a case where a manner of reduction of the remaining amount of the generated encryption keys satisfies a predetermined condition, and • determine that the generation of the encryption key EK by the generation unit 11-i is not normally performed in a case where the manner of reduction of the remaining amount of the generated encryption keys does not satisfy the predetermined condition.

For example, the determination unit 12-i may include a monitor unit 120-i that monitors the remaining amount of the generated encryption keys EK stored in the storage unit 20-i at predetermined time intervals, and may determine that the generation of the encryption key EK by the generation unit 11-i is normally performed in a case where a change in the remaining amount of the encryption keys EK monitored by the monitor unit 120-i is equal to or more than a predetermined threshold, and determine that the generation of the encryption key EK by the generation unit 11-i is not normally performed in a case where the change in the remaining amount of the encryption keys EK monitored by the monitor unit 120-i is less than the predetermined threshold.

Alternatively, the determination unit 12-i may compare a generation amount (supply amount) of the encryption keys EK by the generation unit 11-i with a consumption amount of the encryption keys EK consumed in the encryption communication, and determine that the generation of the encryption key EK is normally performed in a case where the above supply amount of the encryption keys EK exceeds the above consumption amount of the encryption keys EK, and otherwise determine that the generation of the encryption key EK is not normally performed.

Similarly to the first exemplary example embodiment, the determination unit 12-i may acquire, from the management unit 15-i or the input/output unit 16-i included in the communication device 1A-i, information related to • whether calibration is being performed, • whether recovery work from failure is being performed, or • presence or absence of occurrence of a fault, noise, or the like in the communication path, and determine whether the generation of the encryption key by the generation unit 11-i is normally performed with reference to the acquired information.

The determination unit 12-i may acquire a notification indicating that the generation of the encryption key is not normally performed from the communication device 1A-j (j ≠ i) on a partner side, and determine, in a case where the notification is acquired, whether the generation of the encryption key by the generation unit 11-i is normally performed. In response to this, in a case where it is determined that the generation of the encryption key by the generation unit 11-i is not normally performed, the determination unit 12-i may make a notification to the determination unit 12-j included in the communication device 1A-j (j ≠ i) on the partner side indicating that the generation of the encryption key is not normally performed.

### Selection Unit 13-i

The selection unit 13-i selects, according to a determination result by the determination unit 12-i, any one of first communication processing using a first authentication key that is the authentication key AK generated from the encryption key EK and second communication processing that does not consume the encryption key EK. As an example, the selection unit 13-i performs processing of • selecting the first communication processing in a case where the determination unit 12-i determines that the generation of the encryption key EK is normally performed, and . selecting the second communication processing in a case where the determination unit 12-i determines that the generation of the encryption key EK is not normally performed. Here, the first communication processing is an example of the above-described encryption communication.

The second communication processing may also be regarded as an example of the above-described encryption communication. However, in the second communication processing, the encryption key generated by the generation unit 11-i is not consumed.

The second communication processing may be communication processing using a second authentication key DAK that is an authentication key generated without using the encryption key EK. Here, the second authentication key is also referred to as the dummy authentication key DAK, and is, as an example, an authentication key randomly generated by the generation unit 11-i independently of the encryption key EK. An authentication key predetermined as the dummy authentication key DAK may be stored in the storage unit 20-i, and the selection unit 13-i may read and use the dummy authentication key DAK. A plurality of authentication keys predetermined as candidates of the dummy authentication key DAK may be stored in the storage unit 20-i, any one of the authentication keys may be selected by the selection unit 13-i based on a predetermined selection logic, and the selected authentication key may be used as the dummy authentication key DAK. In this case, it is preferable that • the plurality of candidates of the dummy authentication key DAK and • the above selection logic, which are used in the selection unit 13-1 and the selection unit 13-2, are the same.

As an example, the communication processing selected by the selection unit 13-i is executed in the above-described authentication process included in the key generation protocol executed by the generation unit 11-i with the generation unit 11-j (j ≠ i) or an authentication process associated with the key generation protocol. These authentication processes may be executed via the execution unit 14-i to be described below. The authentication processes include, as an example, message authentication between the generation unit 11-i and the generation unit 11-j (j ≠ i). More specifically, the authentication processes include transmission and reception of a message authentication code (MAC) between the generation unit 11-i and the generation unit 11-j (j ≠ i). The communication processing selected by the selection unit 13-i is executed via the classical communication path P2, as an example. However, these examples do not limit the present exemplary example embodiment.

### Execution Unit 14-i

The execution unit 14-i executes the communication processing (the first communication processing or the second communication processing) selected by the selection unit 13-i. The execution unit 14-i may be configured as a part of the above-described generation unit 11-i.

The execution unit 14-i may execute safety confirmation processing in the first communication processing or prior to the first communication processing in a case where the determination unit 12-i determines that the generation of the encryption key EK is normally performed after determining that the generation of the encryption key EK is not normally performed (that is, in a case where the calibration is ended or the failure or the fault is recovered). As an example, the execution unit 14-i may execute, as the safety confirmation processing, • processing of confirming whether the calibration is normally performed, • processing of confirming whether the failure or the fault is normally recovered, and the like. Specifically, processing of comparing the generation amount (supply amount) of the encryption keys EK by the generation unit 11-i with the consumption amount of the encryption keys EK consumed in the encryption communication, and confirming whether the above supply amount of the encryption keys EK exceeds the above consumption amount of the encryption keys EK may be executed. Processing of confirming that the number of photons detected or a bit error rate on a reception side is a normal value, or the like may be performed.

### Management Unit 15-i

The management unit 15-i manages an operation of each unit included in the communication device 1A-i. The management unit 15-i may be expressed as a control unit that controls the operation of each unit included in the communication device 1A-i. As an example, in a case where an instruction to start calibration is received from the input/output unit 16-1 to be described below, the management unit 15-i changes an operation mode of the communication device 1A-i to a calibration mode.

The management unit 15-i may be able to identify • whether recovery work from the failure is being performed or • presence or absence of occurrence of a fault, noise, or the like in the communication path, with reference to information from the generation unit 11-i or the execution unit 14-i, or with reference to information received by the input/output unit 16-i.

### input/Output Unit 16-i

The input/output unit 16-i is connected to, as an example, input/output devices such as a keyboard, a mouse, a display, a printer, and a touch panel. The input/output unit 16-i receives inputs of various types of information with respect to the communication device 1A-i from the connected input device. The input/output unit 16-i outputs various types of information to the connected output device under the control of the management unit 15-i. Examples of the input/output unit 16-i include an interface such as, for example, a universal serial bus (USB).

### Flow of Processing in Communication Device 1A-i

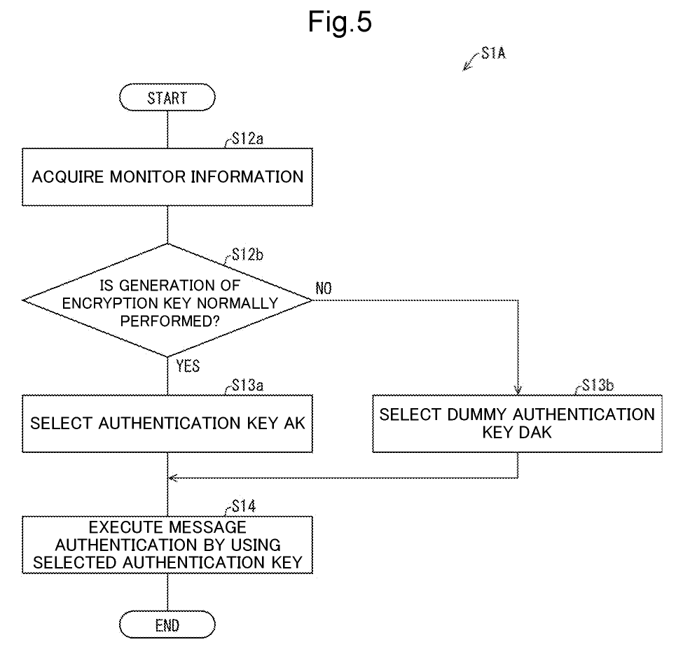

Subsequently, a flow of processing in the communication device 1A-i will be described with reference to FIG. 5. FIG. 5 is a flowchart illustrating the flow of the processing in the communication device 1A-i.

### Step S12a

In step S12a, the monitor unit 120-i included in the determination unit 12-i acquires monitor information. Here, the monitor information includes information related to at least any one of • a remaining amount of generated encryption keys accumulated in the generation unit 11-i, • whether calibration is being performed, • whether recovery work from failure is being performed, and • presence or absence of occurrence of a fault, noise, or the like in the communication path.

### Step S12b

Subsequently, in step S12b, the determination unit 12-i refers to the monitor information acquired in step S12a and determines whether the generation of the encryption key by the generation unit 11-i is normally performed. Since the specific determination processing by the determination unit 12-i has been described above, description thereof will be omitted here. In a case where it is determined that the generation of the encryption key by the generation unit 11-i is normally performed (YES in step S12b), the processing proceeds to step S13a, and otherwise (NO in step S12b), the processing proceeds to step S13b.

### Step S13a

In a case where it is determined in step S12b that the generation of the encryption key is normally performed, the selection unit 13-i selects the authentication key AK in step S13a. Here, the authentication key AK is an authentication key generated from the encryption key EK generated by the generation unit 11-i according to a predetermined key generation protocol.

### Step S13b

On the other hand, in a case where it is determined in step S12b that the generation of the encryption key is not normally performed, the selection unit 13-i selects the dummy authentication key DAK in step S13b.

Here, the dummy authentication key DAK is, as an example, an authentication key randomly generated independently of the encryption key EK, as described above.

### Step S14

In step S14, the generation unit 11-i (or 14-i) performs message authentication with the communication device 1A-j (j ≠ i) on the partner side by using the authentication key (the authentication key AK or the dummy authentication key DAK) selected in step S13a or step S13b.

### Effect of Communication System 100A

As described above, the communication device 1A-i included in the communication system 100A includes

the generation unit 11-i that generates an encryption key consumed in encryption communication,

the determination unit 12-i that determines whether the generation of the encryption key by the generation unit 11-i is normally performed, and

the selection unit 13-i that selects, according to a determination result by the determination unit 12-i, any one of first communication processing using a first authentication key that is an authentication key generated from the encryption key and second communication processing that does not consume the encryption key. Therefore, with the above configuration, it is possible to suppress reduction in a remaining amount of the encryption keys even in a case where the generation of the encryption keys is not normally performed.

### Example of Key Generation Protocol

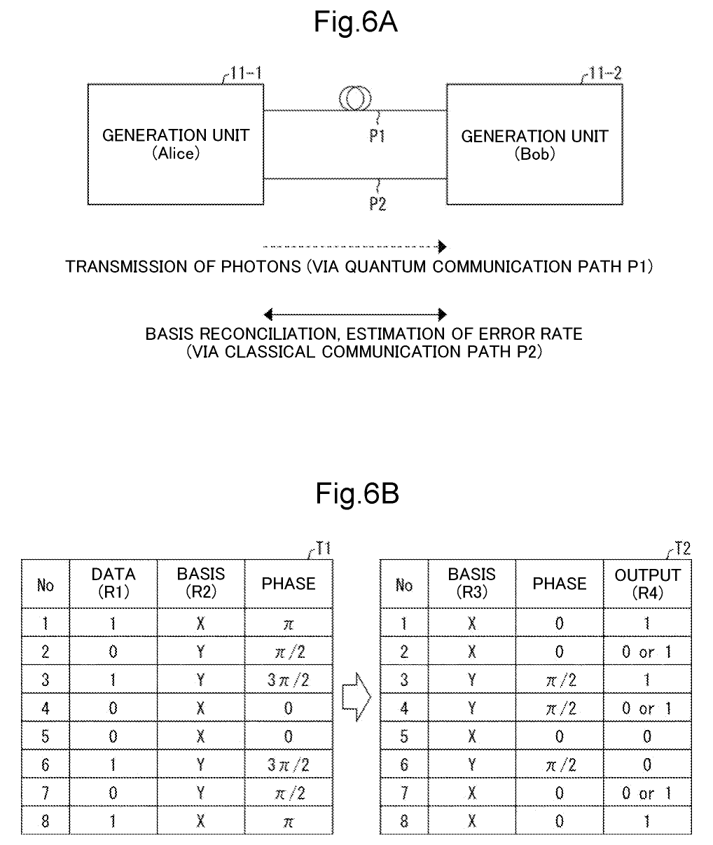

Hereinafter, an example of the key generation protocol executed by the generation unit 11-1 and the generation unit 11-2 will be described with reference to FIG. 6A and 6B. In the following example, it is assumed that the generation unit 11-1 is a transmitter (Alice) and the generation unit 11-2 is a receiver (Bob), and a representative quantum encryption key distribution algorithm referred to as a BB84 protocol will be described as an example. However, the example does not limit the present exemplary example embodiment.

As illustrated in FIG. 6A, in QKD, the generation unit (key generation unit) 11-1 (Alice) and the generation unit (key generation unit) 11-2 (Bob) connected by the quantum communication path P1 constitute an optical interferometer, and each photon is randomly subjected to phase modulation by the Alice and the Bob. An output of 0 or 1 is obtained by a difference in the modulation phase depth, and then, by matching some of conditions when output data is measured between the Alice and the Bob, the same bit string can be finally shared between the Alice and the Bob. Here, it is assumed that four patterns of quantum states are used, and the key generation unit 11-1 (Alice) has two random number sources (R1 and R2), and • represents encryption key data of 0 or 1 by one random number R1, and • determines a method of coding information related to the random number R1 by the other random number R2.

More specifically, in a quantum encryption key distribution method of performing coding of four states by using a phase difference between two coherent pulses, two sets of bases, namely, • a coding set (hereinafter, also referred to as an “X basis”) representing a set in which a phase 0 is an encryption key “0” and a phase π is an encryption key “1”, and a coding set (hereinafter, also referred to as a “Y basis”) representing a set in which a phase π/2 is the encryption key “0” and a phase 3π/2 is the encryption key “1” are selected by the random number R2. That is, the key generation unit 11-1 (Alice) randomly performs four patterns of modulation of 0, π/2, π, and 3π/2 on one photon, and transmits the photon subjected to the modulation to the key generation unit 11-2 (Bob).

In a left side of FIG. 6B, as such a transmission example, a table T1 indicating data (random number R1), a basis (random number R2), and a phase associated with each photon of No. 1 to No. 8 is illustrated. For example, as indicated in the table T1, the phase π is applied to the photon of No. 1 by using the basis X, and the encryption key data 1 is transmitted to the key generation unit 11-2 (Bob) by the photon.

On the other hand, the key generation unit 11-2 (Bob) has a random number source (random number R3) related to a basis, and decodes a photon transmitted from the key generation unit 11-1 (Alice). In a case where a value of the random number R3 is “0”, modulation of the phase 0 (X basis) is performed on the photon, and in a case where the value is “1”, modulation of the phase π/2 (Y basis) is performed on the photon. Here, a random number obtained as an optical interferometer output is referred to as a random number R4.

In a case where the bases of the modulation performed by both the key generation unit 11-1 (Alice) and the key generation unit 11-2 (Bob) are the same (the random number R2 = the random number R3), the key generation unit 11-2 (Bob) can correctly detect a value of the random number R1 (that is, the random number R1 = the random number R4). On the other hand, in a case where the bases of the modulation performed by both are different (the random number R2 ≠ the random number R3), the key generation unit 11-2 (Bob) randomly obtains the value of 0 or 1 as the random number R4 regardless of the value of the random number R1.

In a right side of FIG. 6B, as such a reception example, a table T2 indicating a basis (R3), a phase, and an output (R4) selected for each of the photons of No. 1 to No. 8 illustrated in the above-described table T1 is illustrated. For example, as indicated in the table T2, the basis X and the phase 0 are selected for the photon of No. 1 transmitted from the key generation unit 11-1 (Alice), and the encryption key data 1 is decoded as the output (R4).

Since all of the random numbers R1, R2, and R3 are random numbers that change every bit, a probability that the bases match and a probability that the bases do not match are both 50%. However, in processing in a subsequent stage, as an example, since bits whose bases do not match are deleted by basis reconciliation performed via the classical communication path P2, the key generation unit 11-1 (Alice) and the key generation unit 11-2 (Bob) can share the 0/1 bit string related to the random number R1.

In this manner, the random number shared between the key generation unit 11-1 (Alice) and the key generation unit 11-2 (Bob) is stored in the storage units 20-1 and 20-2 as the encryption key EK, and used for generation of the authentication key AK.

In the QKD system, first, an authentication process of authenticating whether a communication device on a transmission side (also referred to as Alice) and a communication device on a reception side (also referred to as Bob) are correct communication partners using an authentication key (initial key) is executed. When this initial authentication succeeds, a key generation process is started between the Alice and the Bob. This authentication process is important for determining whether the key generation process is started between the authorized communication devices. Therefore, it is desirable that the authentication key is discarded once used.

On the other hand, in the communication device constituting the QKD system, as an example, there may be a situation in which generation of an encryption key used to generate the authentication key is not normally performed due to performance of calibration, recovery work from failure, occurrence of a fault or noise in the communication path, or the like. In the conventional technologies described in JP 2016-181814 A and the like, there is a problem that, even in such a case, a remaining amount of the generated encryption keys is reduced because the encryption keys generated so far are used for the authentication process.

The present disclosure has been made in view of the above problem, and an exemplary object of the present disclosure is to provide a technology capable of suppressing reduction in a remaining amount of encryption keys even in a case where generation of the encryption keys is not normally performed.

According to an exemplary aspect of the present disclosure, it is possible to suppress reduction in a remaining amount of encryption keys even in a case where generation of the encryption keys is not normally performed.

### Example of Achievement by Software

Some or all of the functions of the communication devices 1, 1-1, 1-2, 1A-1, and 1A-2 (hereinafter, also referred to as “each of the above devices”) may be achieved by hardware such as an integrated circuit (an IC chip) or may be achieved by software.

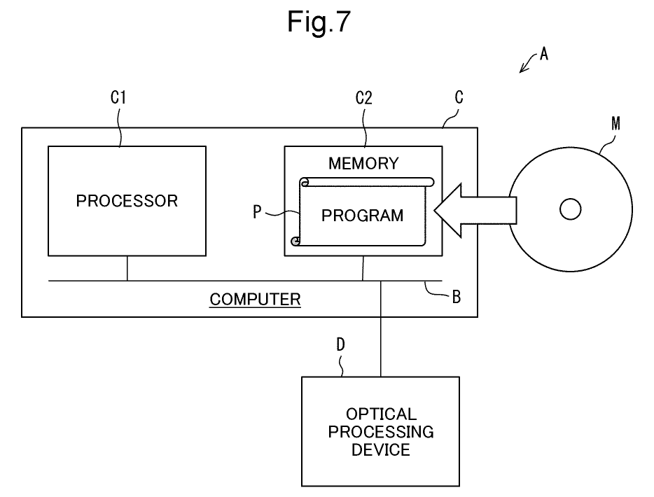

In the latter case, each of the above devices is achieved by, for example, a computer that executes a command of a program that is software that achieves each function. FIG. 7 illustrates an example of the communication devices 1, 1-1, 1-2, 1A-1, and 1A-2 including such a computer (hereinafter, referred to as a device A including a computer C). FIG. 7 is a block diagram illustrating a hardware configuration including the computer C functioning as each of the above devices.

The computer C functions as a communication control device. More specifically, the computer C functions as, as an example, the determination units 12 and 12-1, the selection units 13 and 13-1, and the management unit 15-1. The computer C may execute some of the functions of the above-described execution unit 14-1. An optical processing device D (generator) is connected to the computer C via a bus B as an example, and the optical processing device D functions as the above-described generation units 11 and 11-1 as an example.

The computer C includes at least one processor C1 and at least one memory C2. A program P for causing the computer C to operate as each of the above devices is recorded in the memory C2. In the computer C, by the processor C1 reading the program P from the memory C2 and executing the program P, each function of each of the above devices is achieved.

As an example, the program P is a program for causing the computer to function as the communication control device, and the computer is caused to execute

determination processing of determining whether generation of an encryption key consumed in encryption communication by generation means for generating the encryption key is normally performed, and

selection processing of selecting, according to a determination result by the determination processing, any one of first communication processing using a first authentication key that is an authentication key generated from the encryption key and second communication processing that does not consume the encryption key.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used. As the memory C2, for example, a flash memory, a hard disk drive (HDD), a solid state drive (SSD), or a combination of these can be used.

The computer C may further include a random access memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, or a programmable logic circuit can be used.

The computer C can acquire the program P via such a recording medium M. The program P can be transmitted via a transmission medium. As such a transmission medium, for example, a communication network or a broadcast wave can be used. The computer C can also acquire the program P via such a transmission medium.

Each of the above functions of each of the above devices may be achieved by a single processor provided in a single computer, may be achieved by cooperation of a plurality of processors provided in a single computer, or may be achieved by cooperation of a plurality of processors provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in a plurality of computers.

### Supplementary Note A

The present disclosure includes technologies described in the following Supplementary Notes. However, the present disclosure is not limited to the technologies described in the following Supplementary Notes, and various modifications can be made within the scope described in the claims.

### Supplementary Note A1

A communication device including:

generation means for generating an encryption key consumed in encryption communication;

determination means for determining whether the generation of the encryption key by the generation means is normally performed; and

selection means for selecting, according to a determination result by the determination means, any one of first communication processing using a first authentication key that is an authentication key generated from the encryption key and second communication processing that does not consume the encryption key.

### Supplementary Note A2

The communication device according to Supplementary Note A1, in which

the selection means

selects the first communication processing in a case where the determination means determines that the generation of the encryption key is normally performed, and

selects the second communication processing in a case where the determination means determines that the generation of the encryption key is not normally performed.

### Supplementary Note A3

The communication device according to Supplementary Note A2, in which

the selection means

selects the second communication processing using a second authentication key that is an authentication key generated without using the encryption key in a case where the determination means determines that the generation of the encryption key is not normally performed.

### Supplementary Note A4

The communication device according to any one of Supplementary Notes A1 to A3, in which the first communication processing and the second communication processing include message authentication.

Supplementary Note A5

The communication device according to any one of Supplementary Notes A1 to A4, in which the determination means determines whether the generation of the encryption key by the generation means is normally performed with reference to a remaining amount of the encryption keys generated by the generation means.

Supplementary Note A6

The communication device according to any one of Supplementary Notes A1 to A5, further including

execution means for executing,

in a case where the determination means determines that the generation of the encryption key is normally performed after determining that the generation of the encryption key is not normally performed,

safety confirmation processing in the first communication processing or prior to the first communication processing.

### Supplementary Note A7

A communication system including a first communication device and a second communication device,

the first communication device including:

first generation means for generating an encryption key consumed in encryption communication;

first determination means for determining whether the generation of the encryption key by the first generation means is normally performed; and

first selection means for selecting, according to a determination result by the first determination means, any one of first communication processing using a first authentication key that is an authentication key generated from the encryption key and second communication processing that does not consume the encryption key,

the second communication device including:

second generation means for generating an encryption key consumed in encryption communication;

second determination means for determining whether the generation of the encryption key by the second generation means is normally performed; and

second selection means for selecting, according to a determination result by the second determination means, any one of first communication processing using a first authentication key that is an authentication key generated from the encryption key and second communication processing that does not consume the encryption key.

### Supplementary Note B

The present disclosure includes technologies described in the following Supplementary Notes. However, the present disclosure is not limited to the technologies described in the following Supplementary Notes, and various modifications can be made within the scope described in the claims.

### Supplementary Note B1

A communication method including:

determining, by at least one processor, whether generation of an encryption key consumed in encryption communication by generation means for generating the encryption key is normally performed; and

selecting, by at least one processor, according to a determination result by the determining, any one of first communication processing using a first authentication key that is an authentication key generated from the encryption key and second communication processing that does not consume the encryption key.

### Supplementary Note B2

The communication method according to Supplementary Note B1, in which

in the selecting, the processor

selects the first communication processing in a case where the determination means determines that the generation of the encryption key is normally performed, and

selects the second communication processing in a case where the determination means determines that the generation of the encryption key is not normally performed.

### Supplementary Note B3

The communication method according to Supplementary Note B2, in which

in the selecting, the processor

selects the second communication processing using a second authentication key that is an authentication key generated without using the encryption key in a case where it is determined in the determining that the generation of the encryption key is not normally performed.

### Supplementary Note B4

The communication method according to any one of Supplementary Notes B1 to B3, in which the first communication processing and the second communication processing include message authentication.

### Supplementary Note B5

The communication method according to any one of Supplementary Notes B1 to B4, in which, in the determining, it is determined whether the generation of the encryption key by the generation means is normally performed with reference to a remaining amount of the encryption keys generated by the generation means.

### (Supplementary Note B6)

The communication method according to any one of Supplementary Notes B1 to B5, further including

executing,

in a case where it is determined in the determining that the generation of the encryption key is normally performed after determining that the generation of the encryption key is not normally performed,

safety confirmation processing in the first communication processing or prior to the first communication processing.

### Supplementary Note C

The present disclosure includes technologies described in the following Supplementary Notes. However, the present disclosure is not limited to the technologies described in the following Supplementary Notes, and various modifications can be made within the scope described in the claims.

### Supplementary Note C1

A program for causing a computer to function as a communication control device, the computer being caused to execute:

determination processing of determining whether generation of an encryption key consumed in encryption communication by generation means for generating the encryption key is normally performed; and

selection processing of selecting, according to a determination result by the determination processing, any one of first communication processing using a first authentication key that is an authentication key generated from the encryption key and second communication processing that does not consume the encryption key.

### Supplementary Note C2

The program according to Supplementary Note C1, in which,

in the selection processing,

the first communication processing is selected in a case where it is determined in the determination processing that the generation of the encryption key is normally performed, and

the second communication processing is selected in a case where it is determined in the determination processing that the generation of the encryption key is not normally performed.

### Supplementary Note C3

The program according to Supplementary Note C2, in which,

in the selection processing,

the second communication processing using a second authentication key that is an authentication key generated without using the encryption key is selected in a case where it is determined in the determination processing that the generation of the encryption key is not normally performed.

### Supplementary Note C4

The program according to any one of Supplementary Notes C1 to C3, in which the first communication processing and the second communication processing include message authentication.

### Supplementary Note C5

The program according to any one of Supplementary Notes C1 to C4, in which, in the determination processing, it is determined whether the generation of the encryption key by the generation means is normally performed with reference to a remaining amount of the encryption keys generated by the generation means.

### Supplementary Note C6

The program according to any one of Supplementary Notes C1 to C5, for causing the computer to further execute execution processing of executing,

in a case where it is determined in the determination processing that the generation of the encryption key is normally performed after determining that the generation of the encryption key is not normally performed,

safety confirmation processing in the first communication processing or prior to the first communication processing.

### Supplementary Note D

The present disclosure includes technologies described in the following Supplementary Notes. However, the present disclosure is not limited to the technologies described in the following Supplementary Notes, and various modifications can be made within the scope described in the claims.

### Supplementary Note D1

A communication device including:

generation means for generating an encryption key consumed in encryption communication; and one or a plurality of processors, the processor executes:

determination processing of determining whether the generation of the encryption key by the generation means is normally performed; and

selection processing of selecting, according to a determination result by the determination processing, any one of first communication processing using a first authentication key that is an authentication key generated from the encryption key and second communication processing that does not consume the encryption key.

### Supplementary Note D2

The communication device according to Supplementary Note D1, in which

in the selection processing, the processor

selects the first communication processing in a case where the determination means determines that the generation of the encryption key is normally performed, and

selects the second communication processing in a case where the determination means determines that the generation of the encryption key is not normally performed.

### Supplementary Note D3

The communication device according to Supplementary Note D2, in which

in the selection processing, the processor

selects the second communication processing using a second authentication key that is an authentication key generated without using the encryption key in a case where the determination means determines that the generation of the encryption key is not normally performed.

### Supplementary Note D4

The communication device according to any one of Supplementary Notes D1 to D3, in which the first communication processing and the second communication processing include message authentication.

### Supplementary Note D5

The communication device according to any one of Supplementary Notes D1 to D4, in which, in the determination processing, the processor determines whether the generation of the encryption key by the generation means is normally performed with reference to a remaining amount of the encryption keys generated by the generation means.

### Supplementary Note D6

The communication device according to any one of Supplementary Notes D1 to D5, in which

the processor executes,

in a case where the processor determines in the determination processing that the generation of the encryption key is normally performed after determining that the generation of the encryption key is not normally performed,

safety confirmation processing in the first communication processing or prior to the first communication processing.

### Supplementary Note D7

A communication system including: a first communication device; and a second communication device,

the first communication device including:

first generation means for generating an encryption key consumed in encryption communication; and one or a plurality of first processors, the first processor executing:

first determination processing of determining whether the generation of the encryption key by the first generation means is normally performed; and

first selection processing of selecting, according to a determination result by the first determination processing, any one of first communication processing using a first authentication key that is an authentication key generated from the encryption key and second communication processing that does not consume the encryption key,

the second communication device including:

second generation means for generating an encryption key consumed in encryption communication; and one or a plurality of second processors, the second processor executing:

second determination processing of determining whether the generation of the encryption key by the second generation means is normally performed; and

second selection processing of selecting, according to a determination result by the second determination processing, any one of first communication processing using a first authentication key that is an authentication key generated from the encryption key and second communication processing that does not consume the encryption key.

### Supplementary Note E

The present disclosure includes technologies described in the following Supplementary Notes. However, the present disclosure is not limited to the technologies described in the following Supplementary Notes, and various modifications can be made within the scope described in the claims.

### Supplementary Note E1

A non-transitory recording medium recording a program for causing a computer to function as a communication control device, the computer being caused to execute:

determination processing of determining whether generation of an encryption key consumed in encryption communication by generation means for generating the encryption key is normally performed; and

selection processing of selecting, according to a determination result by the determination processing, any one of first communication processing using a first authentication key that is an authentication key generated from the encryption key and second communication processing that does not consume the encryption key.

1. A communication device comprising:
a generator configured to generate an encryption key consumed in encryption communication;
a memory; and
at least one processor communicatively coupled to the generator and the memory,
the at least one processor configured to perform operations to:
determine whether generation of the encryption key by the generator is normally performed; and
select, according to a result of the determination, any one of:
first communication processing using a first authentication key that is an authentication key generated from the encryption key, and
second communication processing that does not consume the encryption key.

2. The communication device according to claim 1, wherein
the selecting comprises:
selecting the first communication processing in a case where the result of the determination indicates that the generation of the encryption key is normally performed, and
selecting the second communication processing in a case where the result of the determination indicates that the generation of the encryption key is not normally performed.

3. The communication device according to claim 2, wherein
the second communication processing is processing using a second authentication key that is generated without using the encryption key.

4. The communication device according to claim 1, wherein
the first communication processing and the second communication processing include message authentication.

5. The communication device according to claim 1, wherein
the at least one processor is further configured to:
determine whether the generation of the encryption key by the generator is normally performed with reference to a remaining amount of the encryption keys generated by the generator.

6. The communication device according to claim 1, wherein the at least one processor is further configured to:
execute a safety confirmation processing prior to or during the first communication processing,
in a case where the determination that the generation of the encryption key is not normally performed is followed by the determination that the generation of the encryption key is normally performed.

7. A communication method comprising:
determining, by at least one processor, whether generation of an encryption key is normally performed, the encryption key being for consumption in encryption communication; and
selecting, by the at least one processor, according to a result of the determining, any one of:
first communication processing using a first authentication key that is an authentication key generated from the encryption key, and
second communication processing that does not consume the encryption key.

8. The communication method according to claim 7, wherein the selecting comprises:
selecting the first communication processing in a case where the result of the determination indicates that the generation of the encryption key is normally performed, and
selecting the second communication processing in a case where the result of the determination indicates that the generation of the encryption key is not normally performed.

9. The communication method according to claim 8, wherein
the second communication processing is processing using a second authentication key that is generated without using the encryption key.

10. The communication method according to claim 7, wherein
the first communication processing and the second communication processing include message authentication.

11. The communication method according to claim 7, wherein the determining is performed with reference to a remaining amount of generated encryption keys.

12. The communication method according to claim 7, further comprising:
executing, by the at least one processor, a safety confirmation processing prior to or during the first communication processing,
in a case where the determination that the generation of the encryption key is not normally performed is followed by the determination that the generation of the encryption key is normally performed.

13. A non-transitory computer-readable storage medium storing instructions that, when executed by at least one processor, cause the at least one processor to perform a method comprising:
determining, by at least one processor, whether generation of an encryption key is normally performed, the encryption key being for consumption in encryption communication; and
selecting, by the at least one processor, according to a result of the determining, any one of:
first communication processing using a first authentication key that is an authentication key generated from the encryption key, and
second communication processing that does not consume the encryption key.

14. The non-transitory computer-readable storage medium of claim 13, wherein the selecting in the method comprises:
selecting the first communication processing in a case where the result of the determination indicates that the generation of the encryption key is normally performed, and
selecting the second communication processing in a case where the result of the determination indicates that the generation of the encryption key is not normally performed.

15. The non-transitory computer-readable storage medium of claim 14, wherein
the second communication processing is processing using a second authentication key that is generated without using the encryption key.

16. The non-transitory computer-readable storage medium of claim 13, wherein
the first communication processing and the second communication processing include message authentication.

17. The non-transitory computer-readable storage medium of claim 13, wherein
the determining is performed with reference to a remaining amount of generated encryption keys.

18. The non-transitory computer-readable storage medium of claim 13, wherein the method further comprises:
executing, by the at least one processor, a safety confirmation processing prior to or during the first communication processing,
in a case where the determination that the generation of the encryption key is not normally performed is followed by the determination that the generation of the encryption key is normally performed.
